(19) United States
(12) Patent Application Publication
(10) Pub. No.: US 2017/0200103 A1
(43) Pub. Date: Jul. 13, 2017

(54) TECHNIQUES FOR POSITIONING ENERGY INFRASTRUCTURE

(71) Applicant: Nature Conservancy, The, Arlington, VA (US)

(72) Inventors: Nels JOHNSON, Bozeman, MT (US); Tamara GAGNOLET, Harrisburg, PA (US); Thomas MINNEY, Elkins, WV (US)

(73) Assignee: Nature Conservancy, The, Arlington, VA (US)

(21) Appl. No.: 15/400,317

(22) Filed: Jan. 6, 2017

Related U.S. Application Data
(60) Provisional application No. 62/276,304, filed on Jan. 8, 2016.

(51) Int. Cl. G06Q 10/06; G06Q 50/26; G06Q 50/06

(52) U.S. Cl. CPC G06Q 10/06313; G06Q 50/06; G06Q 50/26

(57) ABSTRACT

Techniques for positioning energy infrastructure such as petroleum well pads, and related access roads and gathering pipelines are disclosed. In one embodiment, a system for positioning energy infrastructure comprises one or more processors. The one or more computer processors are configured to receive user input. The user input comprises a boundary where energy infrastructure is placed within and additional features to consider when positioning energy infrastructure. The one or more processors are further configured to store, in a shareable format, a plurality of layouts for the energy infrastructure and associated metrics and parameters based on the user input and base datasets. The base datasets comprise spatial datasets. The base datasets may also comprise default values for input parameters. The one or more processors are further configured to output, on a display device, the plurality of layouts for the energy infrastructure and the associated metrics and parameters.

### RELATED APPLICATIONS

This application claims priority to U.S. Provisional Patent Application No. 62/276,304, filed Jan. 8, 2016, which is hereby incorporated by reference herein in its entirety.

### FIELD OF THE DISCLOSURE

The present disclosure relates generally to energy development and, more particularly, to techniques for determining the placement of energy infrastructure.

### BACKGROUND OF THE DISCLOSURE

Determining appropriate placement of energy infrastructure can often be challenging. For example, various factors must be considered when selecting the placement of a drilling pad for petroleum wells. Sufficient access to the reservoir (i.e., an underground pocket of gas and/or oil) must be achieved while also taking into consideration the state of the surface topology and terrain around the reservoir such as existing infrastructure, forests, and wetlands. However, visualizing and managing this large volume of information to determine an appropriate placement of drilling pads for petroleum wells, and related access roads and gathering pipelines can be overwhelming. For example, it is difficult for a user to easily visualize layouts that have minimal environmental impact and optimized impact/cost tradeoff, particularly when planning multiple well pads at the same time.

In view of the foregoing, there may be significant problems and shortcomings associated with traditional techniques for determining the appropriate placement of energy infrastructure, including, for example, petroleum well pads, and access roads and gathering pipelines.

### SUMMARY OF THE DISCLOSURE

Techniques for positioning energy infrastructure are disclosed. An example placement of energy infrastructure may be petroleum well pads, and related access roads and gathering pipelines. In one embodiment, a system for positioning energy infrastructure comprises one or more processors. The one or more computer processors are configured to receive user input. The user input comprises a boundary where energy infrastructure is placed within. The user input may also comprise additional features to consider when positioning energy infrastructure. The one or more processors are further configured to store, in a shareable format, a plurality of layouts for the energy infrastructure and associated metrics and parameters based on the user input and base datasets. The base datasets comprise spatial datasets. The base datasets may also comprise default values for input parameters. The one or more processors are further configured to output, on a display device, the plurality of layouts for the energy infrastructure and the associated metrics and parameters.

In accordance with other aspects of this embodiment, the user input comprises at least one of an exclusion distance and a maximum impact distance. In accordance with other aspects of this embodiment, at least one of the user input and the base datasets comprise state regulations. In accordance with other aspects of this embodiment, the associated metrics comprise tradeoff of cost and environmental impact. In accordance with other aspects of this embodiment, the one or more processors are further configured to present one of the plurality of layouts as an optimized layout. In accordance with other aspects of this embodiment, the base datasets are based on at least one of existing environmental features and infrastructure, industry standards, or environmental best practices. In some embodiments, layout information associated with an oil and/or gas well is represented to a user in a map representation, with different annotations for oil/gas pads, access roads, and gathering pipelines. Associated cost and environmental impact for a layout is visually represented to a user through easy-to-compare mechanisms, such as bar charts. A user can select a specific metric to assess, such as base cost and forest acreage lost. User input is streamlined, such that a user only needs to enter a limited number of parameters. Other parameters may also be customized through input files. User input and base data are combined to derive alternative layouts with associated metrics.

In another embodiment, the techniques may be realized as a method for positioning energy infrastructu. According to the method, user input may be received. The user input may comprise a boundary where energy infrastructure is placed within. A plurality of layouts for the energy infrastructure and associated metrics and parameters may be stored in a shareable format, based on the user input and base datasets. The base datasets may comprise spatial data. The plurality of layouts for the energy infrastructure and the associated metrics and parameters may be output on a display device.

In accordance with other aspects of this embodiment, the user input comprises at least one of an exclusion distance and a maximum impact distance. In accordance with other aspects of this embodiment, at least one of the user input and the base datasets comprise state regulations. In accordance with other aspects of this embodiment, the associated metrics comprise tradeoff of cost and environmental impact. In accordance with other aspects of this embodiment, the one or more processors are further configured to present one of the plurality of layouts as an optimized layout. In accordance with other aspects of this embodiment, the base datasets are based on at least one of existing environmental features and infrastructure, industry standards, or environmental best practices. In some embodiments, layout information associated with an oil and/or gas well is represented to a user in a map representation, with different annotations for oil/gas pads, access roads, and gathering pipelines. Associated cost and environmental impact for a layout is visually represented to a user through easy-to-compare mechanisms, such as bar charts. A user can select a specific metric to assess, such as base cost and forest acreage lost. User input is streamlined, such that a user only needs to enter a limited number of parameters. Other parameters may also be customized through input files. User input and base data are combined to derive alternative layouts with associated metrics.

In still another embodiment, the techniques may be realized as a non-transitory computer readable medium storing a computer-readable program of positioning energy infrastructure. The program may include computer-readable instructions to receive user input. The user input comprises a boundary where energy infrastructure is placed within. The program may include computer-readable instructions to store, in a shareable format, a plurality of layouts for the energy infrastructure and associated metrics and parameters based on the user input and base datasets, wherein the base datasets comprise spatial data. The program may include computer-readable instructions to output, on a display device, the plurality of layouts for the energy infrastructure and the associated metrics and parameters.

In accordance with other aspects of this embodiment, the user input comprises at least one of an exclusion distance and a maximum impact distance. In accordance with other aspects of this embodiment, at least one of the user input and the base datasets comprise state regulations. In accordance with other aspects of this embodiment, the associated metrics comprise tradeoff of cost and environmental impact. In accordance with other aspects of this embodiment, the one or more processors are further configured to present one of the plurality of layouts as an optimized layout. In accordance with other aspects of this embodiment, the base datasets are based on at least one of existing environmental features and infrastructure, industry standards, or environmental best practices. In some embodiments, layout information associated with an oil and/or gas well is represented to a user in a map representation, with different annotations for oil/gas pads, access roads, and gathering pipelines. Associated cost and environmental impact for a layout is visually represented to a user through easy-to-compare mechanisms, such as bar charts. A user can select a specific metric to assess, such as base cost and forest acreage lost. User input is streamlined, such that a user only needs to enter a limited number of parameters. Other parameters may also be customized through input files. User input and base data are combined to derive alternative layouts with associated metrics.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram depicting a network architecture in accordance with an embodiment of the present disclosure.

FIG. 2 shows a block diagram depicting a computer system in accordance with an embodiment of the present disclosure.

FIG. 3 shows a block diagram illustrating the interface module shown in FIG. 1 in accordance with an embodiment of the present disclosure.

FIG. 4 shows a flowchart for displaying oil and gas surface infrastructure placement, impact, and cost information on a graphical user interface in accordance with an example method of the present disclosure.

FIG. 5 shows a graphical user interface for displaying oil and gas surface infrastructure placement, impact, and cost information in accordance with an embodiment of the present disclosure.

FIG. 6 shows a graphical user interface for displaying oil and gas surface infrastructure placement, impact, and cost information in accordance with an embodiment of the present disclosure.

FIG. 7 shows a graphical user interface for displaying oil and gas surface infrastructure placement, impact, and cost information in accordance with an embodiment of the present disclosure.

FIG. 8 shows a graphical user interface for displaying oil and gas surface infrastructure placement, impact, and cost information in accordance with an embodiment of the present disclosure.

FIG. 9 shows a graphical user interface for displaying oil and gas surface infrastructure placement, impact, and cost information in accordance with an embodiment of the present disclosure.

FIG. 10 shows a graphical user interface for displaying oil and gas surface infrastructure placement, impact, and cost information in accordance with an embodiment of the present disclosure.

FIG. 11 shows a graphical user interface for displaying oil and gas surface infrastructure placement, impact, and cost information in accordance with an embodiment of the present disclosure.

FIG. 12 shows a graphical user interface for displaying oil and gas surface infrastructure placement, impact, and cost information in accordance with an embodiment of the present disclosure.

FIG. 13 shows a graphical user interface for displaying oil and gas surface infrastructure placement, impact, and cost information in accordance with an embodiment of the present disclosure.

FIG. 14 shows a graphical user interface for displaying oil and gas surface infrastructure placement, impact, and cost information in accordance with an embodiment of the present disclosure.

FIG. 15 shows a graphical user interface for displaying oil and gas surface infrastructure placement, impact, and cost information in accordance with an embodiment of the present disclosure.

FIG. 16 shows a graphical user interface for displaying oil and gas surface infrastructure placement, impact, and cost information in accordance with an embodiment of the present disclosure.

FIG. 17 shows a graphical user interface for displaying oil and gas surface infrastructure placement, impact, and cost information in accordance with an embodiment of the present disclosure.

### DETAILED DESCRIPTION OF EMBODIMENTS

In some embodiments, techniques disclosed herein enable a user to input various factors to be considered when selecting the placement of a drilling pad for oil and gas wells and associated access roads and gathering pipelines. The alternative placements may be represented to the user in a map representation with associated metrics. Various steps and factors for user input, as well as alternative placements as output will be described in further detail.

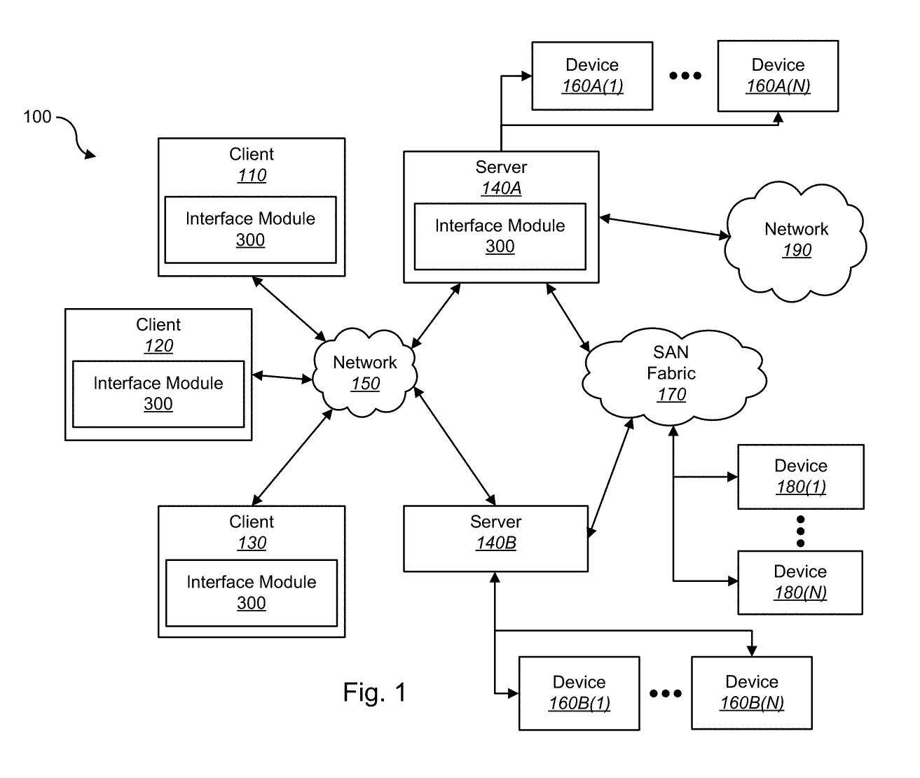

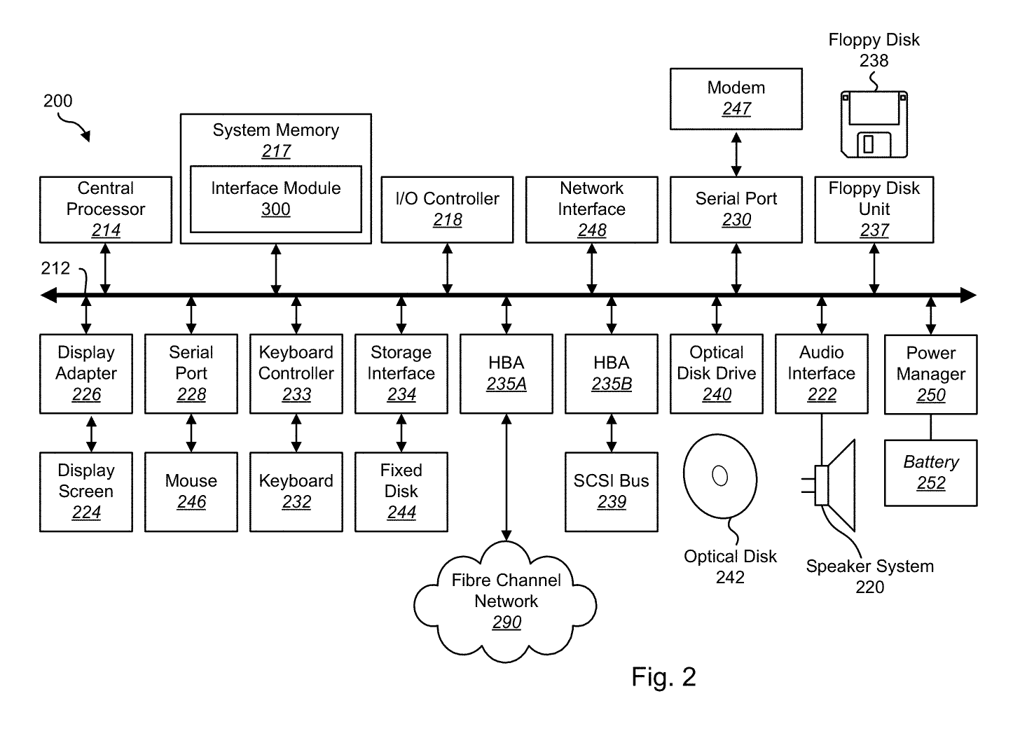

FIG. 1 shows a block diagram depicting a network architecture 100 in accordance with an embodiment of the present disclosure. FIG. 1 is a simplified view of network architecture 100, which may include additional elements that are not depicted, but that are well known to one skilled in the art. Network architecture 100 may contain client systems 110, 120 and 130, as well as servers 140A-140N (one or more of each of which may be implemented using computer system 200 shown in FIG. 2). Client systems 110, 120 and 130 may be communicatively coupled to a network 150. Server 140A may be communicatively coupled to storage devices 160A(1)-(N), and server 140B may be communicatively coupled to storage devices 160B(1)-(N). Servers 140A and 140B may be communicatively coupled to a SAN (Storage Area Network) fabric 170. SAN fabric 170 may support access to storage devices 180(1)-(N) by servers 140A and 140B, and by client systems 110, 120 and 130 via network 150.

With reference to computer system 200 of FIG. 2, modem 247, network interface 248, or some other mechanism may be used to provide connectivity from one or more of client systems 110, 120 and 130 to network 150. Client systems 110, 120 and 130 may access information on server 140A or 140B using, for example, a web browser or other client software (not shown). Such a client may allow client systems 110, 120 and 130 to access data hosted by server 140A or 140B or one of storage devices 160A(1)-(N), 160B(1)-(N), and/or 180(1)-(N).

Networks 150 and 190 may be local area networks (LANs), wide area networks (WANs), the Internet, cellular networks, satellite networks, or other networks that permit communication between clients 110, 120, 130, servers 140, and other devices communicatively coupled to networks 150 and 190. Networks 150 and 190 may further include one, or any number, of the exemplary types of networks mentioned above operating as a stand-alone network or in cooperation with each other. Networks 150 and 190 may utilize one or more protocols of one or more clients or servers to which they are communicatively coupled. Networks 150 and 190 may translate to or from other protocols to one or more protocols of network devices. Although networks 150 and 190 are each depicted as one network, it should be appreciated that according to one or more embodiments, networks 150 and 190 may each comprise a plurality of interconnected networks.

Storage devices 160A(1)-(N), 160B(1)-(N), and/or 180(1)-(N) may be network accessible storage and may be local, remote, or a combination thereof to server 140A or 140B. Storage devices 160A(1)-(N), 160B(1)-(N), and/or 180(1)-(N) may utilize a redundant array of inexpensive disks (“RAID”), magnetic tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), optical based storage, or other computer accessible storage. Storage devices 160A(1)-(N), 160B(1)-(N), and/or 180(1)-(N) may be used for backup or archival purposes. Further, storage devices 160A(1)-(N), 160B(1)-(N), and/or 180(1)-(N) may be implemented as part of a multi-tier storage environment.

According to some embodiments, clients 110, 120, and 130 may be smartphones, PDAs, desktop computers, laptop computers, tablet computers, servers, other computers, or other devices coupled via a wireless or wired connection to network 150. Clients 110, 120, and 130 may receive data from user input, a database, a file, a web service, and/or an application programming interface. In some implementations, clients 110, 120, and 130 may specifically be network-capable mobile devices such as smartphones or tablets.

Servers 140A and 140B may be application servers, archival platforms, backup servers, database servers, network storage devices, media servers, email servers, document management platforms, enterprise search servers, or other devices communicatively coupled to network 150. Servers 140A and 140B may utilize one of storage devices 160A(1)-(N), 160B(1)-(N), and/or 180(1)-(N) for the storage of application data, geographic information system or geographical information system (GIS) data, or other data. Servers 140A and 140B may be hosts, such as an application server, which may process data traveling between clients 110, 120, and 130. According to some embodiments, servers 140A and 140B may be platforms used for backing up and/or archiving geographic information system or geographical information system (GIS) data as well as data associated with oil and gas exploration.

According to some embodiments, clients 110, 120, and 130 may contain one or more portions of software for accessing content via a graphic user interface such as, for example, interface module 300. As illustrated, one or more portions of the interface module 300 may reside at a network centric location. According to some embodiments, network 190 may be an external network (e.g., the Internet) and server 140A may be a gateway or firewall between one or more internal components and clients and the external network. According to some embodiments, the interface module 300 may be implemented as part of a cloud computing environment. For example, the interface module 300 may be distributed to various clients and servers through a cloud computer environment. For another example, the interface module 300 may be updated at the network centric location and then distributed to various clients and servers.

FIG. 2 shows a block diagram of a computer system 200 in accordance with an embodiment of the present disclosure. Computer system 200 may be suitable for implementing methods and systems in accordance with the present disclosure. Computer system 200 may include a bus 212 which may interconnect subsystems of computer system 200, such as a central processor 214, a system memory 217 (e.g. RAM (Random Access Memory), ROM (Read Only Memory), flash RAM, or the like), an Input/Output (I/O) controller 218, an external audio device, such as a speaker system 220 via an audio output interface 222, an external device, such as a display screen 224 via display adapter 226, serial ports 228 and 230, a keyboard 232 (interfaced via a keyboard controller 233 by a wired or wireless connection), a storage interface 234, a floppy disk drive 237 operative to receive a floppy disk 238, a host bus adapter (HBA) interface card 235A operative to connect with a Fibre Channel network 290, a host bus adapter (HBA) interface card 235B operative to connect to a SCSI bus 239, and an optical disk drive 240 operative to receive an optical disk 242. Also included may be a mouse 246 (or other point-and-click device, coupled to bus 212 via serial port 228 by a wired or wireless connection), a modem 247 (coupled to bus 212 via serial port 230), network interface 248 (coupled directly to bus 212), power manager 250, and battery 252.

Bus 212 allows data communication between central processor 214 and system memory 217, which may include read-only memory (ROM) or flash memory (neither shown), and random access memory (RAM) (not shown), as previously noted. The RAM may be the main memory into which the operating system and application programs may be loaded from system memory 217. The ROM or flash memory can contain, among other code, the Basic Input-Output system (BIOS) which controls basic hardware operation such as the interaction with peripheral components. Applications resident with computer system 200 may be stored on and accessed via a computer readable medium, such as a hard disk drive (e.g., fixed disk 244), an optical drive (e.g., optical drive 240), a floppy disk unit 237, a removable disk unit (e.g., Universal Serial Bus drive) (not shown) , or other storage medium. According to some embodiments, the interface module 300 may be resident in system memory 217.

Storage interface 234, as with the other storage interfaces of computer system 200, can connect to a standard computer readable medium for storage and/or retrieval of information, such as a fixed disk drive 244. Fixed disk drive 244 may be a part of computer system 200 or may be separate and accessed through other interface systems. Modem 247 may provide a direct connection to a remote server via a telephone link or to the Internet via an internet service provider (ISP). Network interface 248 may provide a direct connection to a remote server via a direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected to computer system 200 in a similar manner (e.g., document scanners, digital cameras and so on). Conversely, all of the devices shown in FIG. 2 need not be present to practice the present disclosure. The devices and subsystems can be interconnected in different ways from that shown in FIG. 2. Code to implement the present disclosure may be stored in computer-readable storage media such as one or more of system memory 217, fixed disk 244, optical disk 242, or floppy disk 238. Code to implement the present disclosure may also be received via one or more interfaces and stored in memory. The operating system provided on computer system 200 may be MS-DOS®, MS-WINDOWS®, OS/2®, OS X®, UNIX®, Linux®, or another known operating system.

Power manager 250 may monitor a power level of battery 252. Power manager 250 may provide one or more APIs (Application Programming Interfaces) to allow determination of a power level, of a time window remaining prior to shutdown of computer system 200, a power consumption rate, an indicator of whether computer system is on main (e.g., AC Power) or battery power, and other power related information. According to some embodiments, APIs of power manager 250 may be accessible remotely (e.g., accessible to a remote backup management module via a network connection). According to some embodiments, battery 252 may be an Uninterruptable Power Supply (UPS) located either local to or remote from computer system 200. In such embodiments, power manager 250 may provide information about a power level of an UPS.

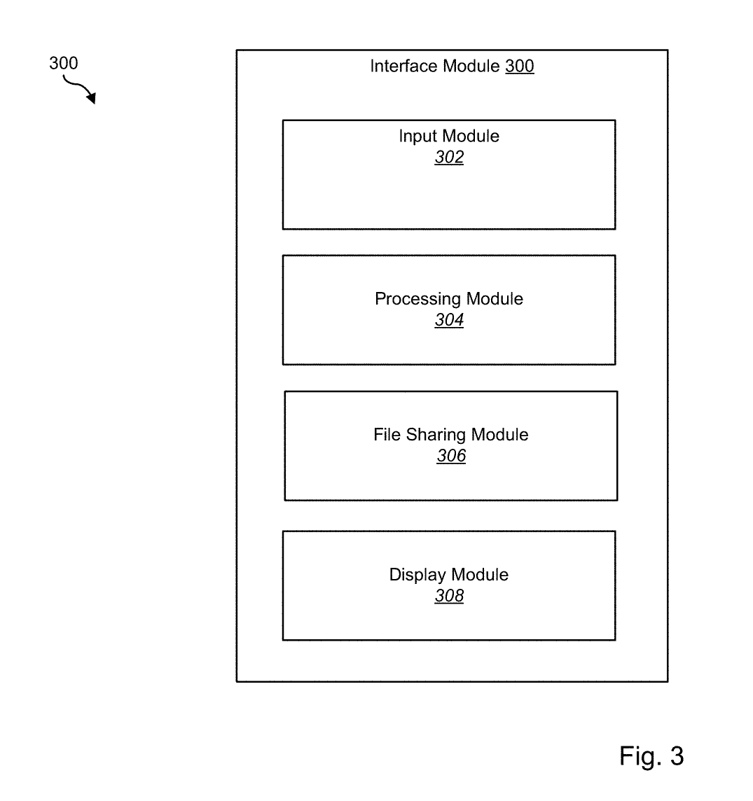

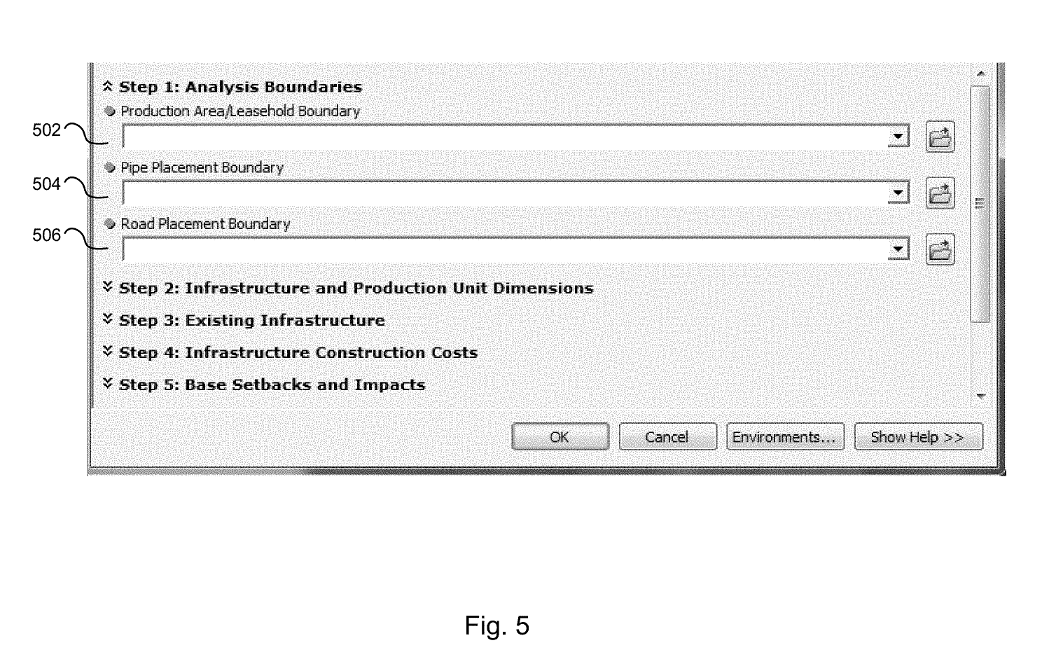

FIG. 3 shows a block diagram illustrating the interface module 300 shown in FIG. 1 in accordance with an embodiment of the present disclosure. The interface module 300 may reside on a client, such as an end-user device, and/or a server, such as a web server. In some embodiments, the interface module 300 includes an input module 302, a processing module 304, a file sharing module 306, and a display module 308. In some implementations, the input module 302 may receive user input, including but not limited to production area boundaries, pad length, and pad width to assist in the placement of a petroleum (e.g., oil or gas) well pads and related access roads and gathering pipelines. User input and associated input flow will be further described in detail in relation to FIGS. 5-11 described below. Briefly, in one embodiment, the input module 302 receives user input in the following steps:

Step 1: Analysis Boundaries;

Step 2: Infrastructure and Production Unit Dimensions;

Step 3: Existing Infrastructure;

Step 4: Infrastructure Construction Costs;

Step 5: Base Setback and Impacts;

Step 6: Additional Setbacks and Impacts;

Step 7: Analysis Settings; and

Step 8: Slope Cost Estimation Tool.

In other embodiments, user input comprises at least one of the above steps in different sequences.

Steps 1-8 will be described in further detail in relation to FIGS. 5-11. Briefly, for step 1, boundary information of the target location where petroleum well pads, and related access roads and gathering lines will be positioned may be specified. At step 2, infrastructure dimension information such as pad length or width may be specified. The dimension information may facilitate the positioning of oil or gas wells within the boundary specified in step 1. At step 3, existing infrastructure information may be specified. In some embodiments, the information may include publicly available infrastructure information as well as what is known by the user, but not by the base data set (e.g., GIS information of the system). For example, a user may specify additional roads that are not reflected in the base data. At step 4, infrastructure construction costs, such as pad baseline cost, may be specified. In some embodiments, the cost is based on industry standards. In other embodiments, the user may specify costs that are different from the default values provided by the system. At step 5, base setback and impacts may be specified. For example, exclusion distance between stream/water and oil or gas wells may be specified. At step 6, additional setbacks and impacts may be specified. For example, a user may specify another layer to define additional setback (exclusion) distances for placing surface infrastructure. At step 7, analysis settings may be specified. For example, a user may specify output directory and base data directory. At step 8, slope cost factor may be specified. For example, a user may specify costs for building roads (e.g., in dollars per square foot) or pipelines (e.g., in dollars per foot) at different slopes, and the corresponding slope cost factor may be reflected. The slope cost factor may be incorporated into road and pipeline construction cost estimates for proposed infrastructure layouts.

In some implementations, the input module 302 receives user input through graphic user interfaces, including but not limited to text boxes, file uploads, drop-down lists, and checkboxes. In other implementations, the input module 302 receives user input via input files, which provides a flexible input mechanism. The input files may include, but are not limited to, text files and spreadsheets. For example, a user can enter parameters through a Microsoft Excel file, which may be processed by the processing module 304. In some implementations, the input module 302 may receive more than 100 parameters from the input files, but provide access to a subset of the parameters via user input through a graphic user interface.

Still referring to FIG. 3, in some implementations, the processing module 304 may process user input entered through graphic user interfaces, input files which may include user input, and other base data. In some embodiments, the processing module 304 may receive the user input and input files from the input module 302 through a network. The user input and input files may also be compressed for transmission across the network. In certain embodiments, the processing module 304 may parse the user input or the input files in a specific manner, based on, for example, delimiters. For example, the processing module 304 may have machine readable instructions to process user input. The processing module 304 may produce one or more alternative layouts with associated data. The layouts may include a map representation indicating the positions of oil or gas well pads, gathering pipelines, access roads, etc. The base datasets include but are not limited to (a) spatial data on land cover, roads, streams, slope, elevation, wetlands, and other environmental and infrastructure information and (b) default values for input parameters including infrastructure dimensions, infrastructure construction costs, and base setback distances for placing infrastructure. In some embodiments, the base data is based on industry standards, for example, the standard industry cost for a well pad in dollar amount per square foot. In some instances, the industry standards are obtained from industry collaborators. In some embodiments, the base data or datasets are based on environmental best practices. The associated data for a layout may include but is not limited to environmental impact and cost. For example, the processing module 304 calculates overall cost based on well cost, road construction cost, etc. The processing module 304 also calculates the environmental impact based forest acreage lost, sediment yield, etc.

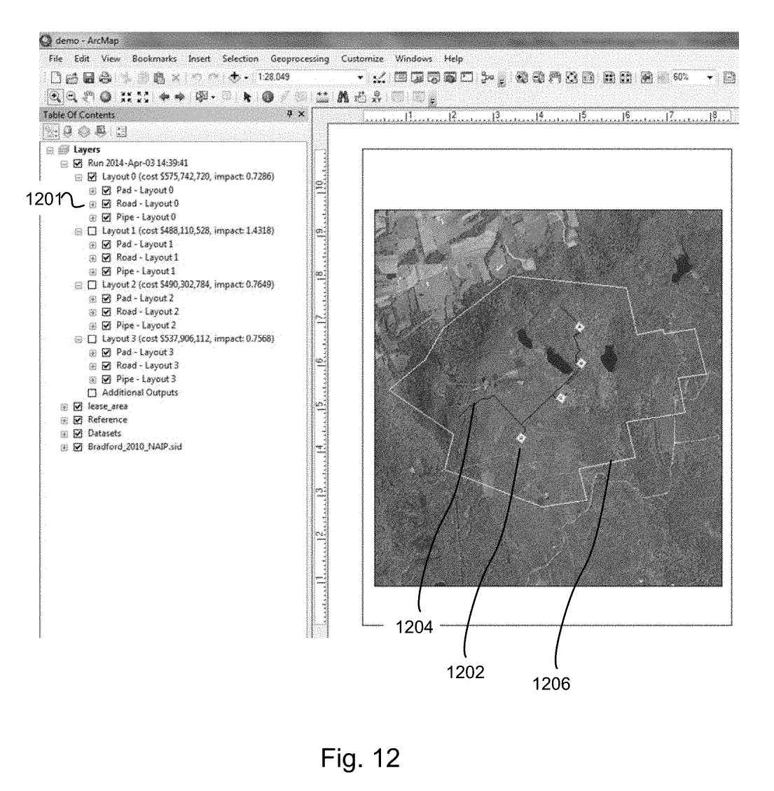

With continued reference to FIG. 3, in some implementations, the file sharing module 306 stores the output produced by the processing module 304 in a shareable format. In some embodiments, shareable formats include, but are not limited to, the Excel file format, and the HTML file format. In some embodiments, processing module 304 sends output to the file sharing module 306. For example, processing module 304 may send output to the file sharing module 306 through an application program interface (API). The API may be a remote API over a network. In some implementations, the processing module may have machine-readable instructions to send output files to the file sharing module 306. In some implementations, output from the processing module 304 may be saved under a base directory and in a sub-directory, marked by the date and the time of the output. Output, such as layouts, metrics, and parameters may be saved in different files. Layouts may include proposed positioning information of well pads, gathering pipelines, and access roads. Metrics may include overall construction costs as well as the overall environmental impact related to each layout. Parameters may include the various parameters that are used to derive the overall costs and environmental impact. For example, parameters may include well pad baseline cost, slope cost, and permit cost. At least some of the files may be HTML files, which may contain links to other files within the same sub-directory or to different portions of the same files. Output files will be described in further details in relation to FIGS. 12-17.

In some implementations, the display module 308 may display the output produced by the processing module 304 and stored by the file sharing module 306. In some embodiments, the display module 308 accesses the files stored by the file sharing module 306 by opening the files according to a specific file format, such as Excel or HTML, extracts data from the files and displays on a user device. In one embodiment, the display module 308 displays different views, including results by layout, results by metric, and infrastructure and input parameters. Layouts may include positioning information of oil and/or gas well pad(s), associated gathering pipeline(s), associated access road(s), as well as other necessary infrastructure. Metrics may include information such as cost and corresponding environmental impact. Parameters may include numerical factors to derive the metric. For example, pad baseline cost is a parameter that may be used to derive an overall cost of a layout. Each view corresponds to a different file saved by the file sharing module 306. In some embodiments, the display module 308 allows a user to select or deselect a layer of a layout and displays the layers of the layout correspondingly. Various display mechanisms will be described in further details in relation to FIGS. 12-17.

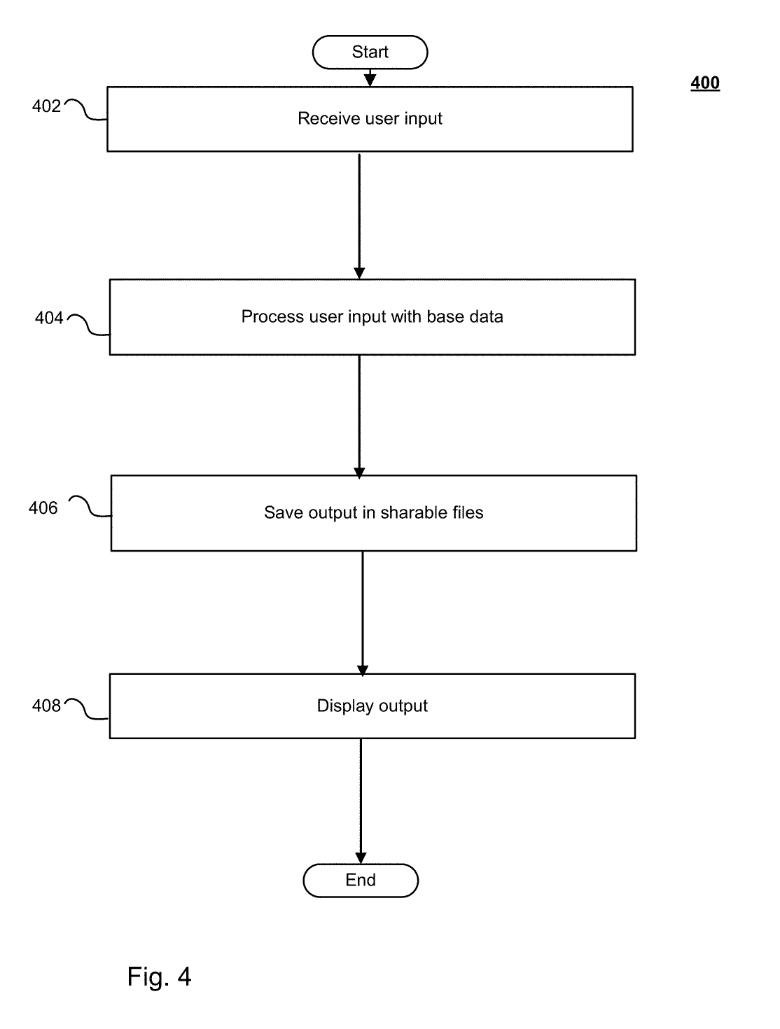

FIG. 4 shows a flowchart for displaying oil and gas well drilling information on a graphical user interface in accordance with an example method of the present disclosure.

Method 400 may include receiving user input (step 402), processing user input with base data (step 404), saving output in sharable files (step 406) and displaying output (step 408). At step 402, the input module 302 receives user input. At step 404, the processing modules 304 processes the user input and produces output. At step 406, the file sharing module 306 saves the output in sharable files. At step 408, the display module 308 displays the output.

Method 400 may include receiving user input (step 402). In some implementations, as described above, user input may be entered through graphic user interfaces, such as text boxes, file uploads, etc. In other implementations, user input may be entered through input files that are configured as input to the system. For example, a user may manually enter “300” for pad length (foot) or a user may upload a file for production area/leasehold boundary. A user may also directly edit an input file as well as a base data directory. For example, a user may edit pad baseline cost ($/square-foot) in an input file in the base data directory. The input file may be a spreadsheet file (e.g., Microsoft Excel file). The first column may indicate a parameter's name. The second column may indicate the value of the parameter. The third column may indicate the unit of a value. Accordingly, in the spreadsheet input file, a user may edit the value that corresponds to the parameter “pad baseline cost.”

At step 404, user input is processed with base data and output is produced. The base data may be based on industry standards, for example, pad baseline cost ($/square-foot). The base data may also reflect state regulations. For example, the minimum setback distance between an oil or gas well pad and a property boundary may be based on a state regulation. A user may also specify additional input. For example, a user may specify additional wetland areas. These additional wetland areas might not be reflected in the base data provided by the system. In some embodiments, additional input specified by the user does not replace the base data. For example, additional wetland area specified by the user does not replace the wetland information specified in the base data. At step 4, user input and base data may be combined together to produce output. Output may include various layouts (e.g., proposed positioning for well pads), metrics (e.g., overall cost and environmental impact) associated with each layout.

At step 406, the output is stored in at least one sharable file. In some implementations, each output is saved under a base directory in a sub-directory marked with data and time of the output. In one embodiment, different aspects of the output, such as layouts, metrics, and infrastructure and input parameters are saved in different files. As described above, layouts may include positioning information. Metrics may include information such as cost or environmental impact. Parameters may include numerical factors to derive the metrics. At step 408, an output is displayed on a device. In some implementations, displayed output is responsive to user interactions. For example, a user may select a specific layer to be displayed. For another example, a user may select a specific metric. In some embodiments, the output may be displayed in HTML formats, with various hyperlinks. A user may click on the links “open results by layout,” “open results by metrics,” etc. As described above, output files may be saved under a sub-directory. Accordingly, through the hyperlinks, a user may be able to open and navigate through various output files.

FIG. 5 shows a graphical user interface for displaying oil and gas surface infrastructure placement, impact, and cost information in accordance with an embodiment of the present disclosure. In some implementations, step 1 of user input “Analysis Boundaries” comprises production area/leasehold boundary 502, pipe placement boundary 504, and road replacement boundary 506. In one embodiment, production area/leasehold boundary 502 is a user input parameter. In some instances, pipe placement boundary 504 and road placement boundary 506 may be inputted if different from production area/leasehold boundary 502.

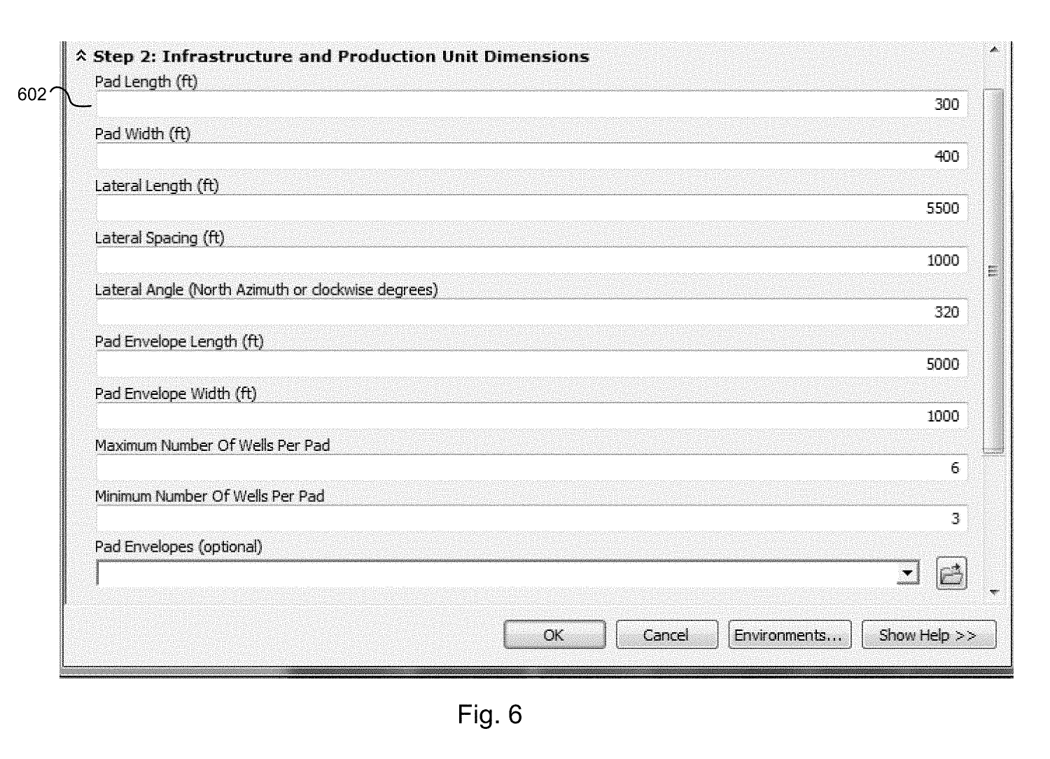

FIG. 6 shows a graphical user interface for displaying oil and gas surface infrastructure placement, impact, and cost information in accordance with an embodiment of the present disclosure. In some implementations, step 2 of user input “Infrastructure and Production Unit Dimensions” comprises infrastructure and product unit dimensions, including but not limited to pad length, pad width, and lateral spacing. In one embodiment, the default input is provided, which may be based on industry standards. In other embodiments, a user may provide their own input regarding infrastructure and product unit dimensions. For example, based on current industry standard, pad length 602 is 300 feet. Accordingly, 300 feet may be provided as the default value. A user may enter her own input, for example, 305 feet as the pad length. This user entered input (as well as other user input) will be incorporated when deriving layouts and metrics. For example, pad length 305 feet may be used to calculate a layout and an overall cost.

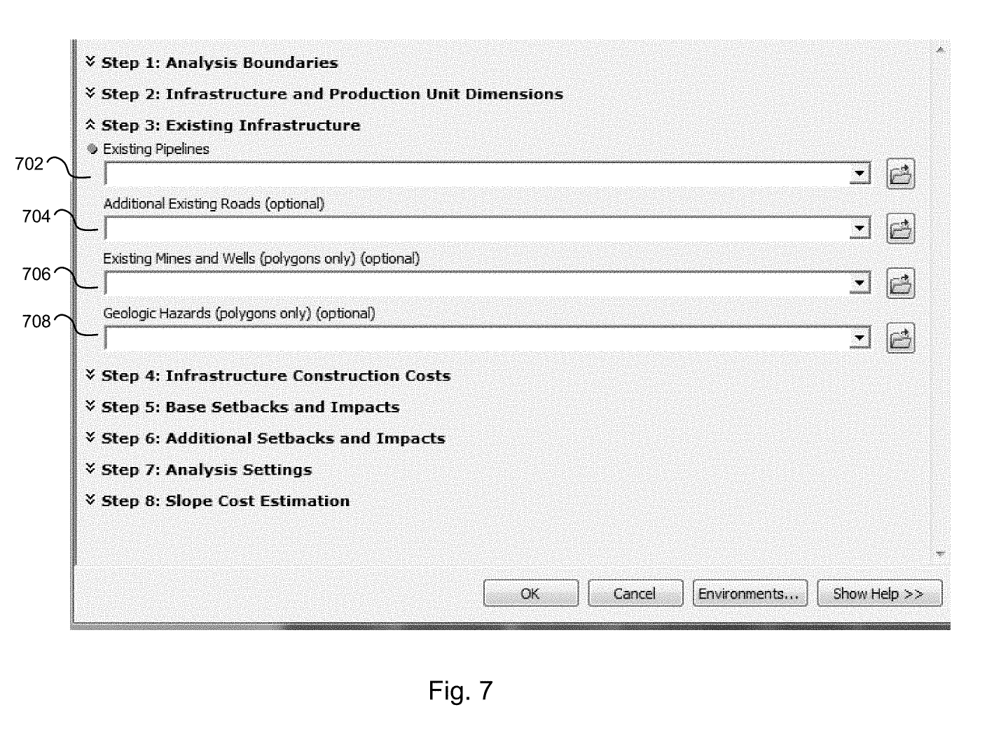

FIG. 7 shows a graphical user interface for displaying oil and gas surface infrastructure placement, impact, and cost information in accordance with an embodiment of the present disclosure. In some implementations, step 3 of user input “Existing Infrastructure” comprises infrastructure such as roads, pipelines, etc. In one embodiment, this step allows a user to enter existing infrastructure that is not present in the base data. For example, a user may upload additional information regarding pipelines 702, roads 704, existing mines and wells 706, and geologic hazards 708. In some embodiments, this additional information regarding infrastructure may be incorporated when deriving layouts and metrics. For example, well pads may be positioned away from existing mines and wells 706 and geologic hazards 708. Costs may be decreased by utilizing additional existing roads 704 in proposed infrastructure layouts. For example, if additional existing roads are present, less roads may be built, resulting in decreased costs.

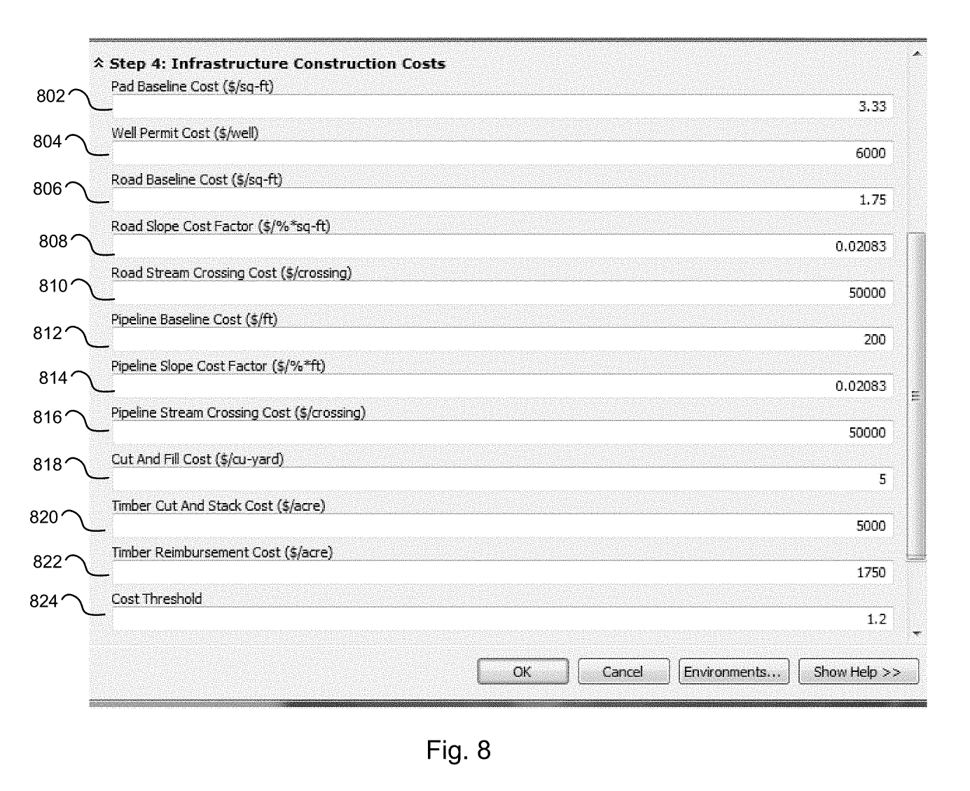

FIG. 8 shows a graphical user interface for displaying oil and gas surface infrastructure placement, impact, and cost information in accordance with an embodiment of the present disclosure. In some implementations, step 4 of user input “Infrastructure Construction Costs” comprises infrastructure construction costs. Infrastructure construction cost includes, but is not limited to, pad baseline cost ($/square-foot) 802, well permit cost ($/well) 804, road baseline cost ($/square-foot) 806, road slope cost factor ($/%*square-foot) 808, road stream crossing cost ($/crossing) 810, pipeline baseline cost ($/foot) 812, pipeline slope cost factor ($/%*foot) 814, pipeline stream crossing cost ($/crossing) 816, cut and fill cost ($/cubic-yard) 818, timber cut and stack cost ($/acre) 820, timber reimbursement cost ($/acre) 822, and cost threshold 824. In one embodiment, default costs based on industry standards are provided. A user may provide cost data and override the default data. For example, if the siting is located in a rocky area, the user may enter higher than industry standard cost for cut and fill cost. By way of example, rather than using the default value of $5/cubic-yard, the user may enter $6/cubic-yard. Accordingly, overall cost may also be increased.

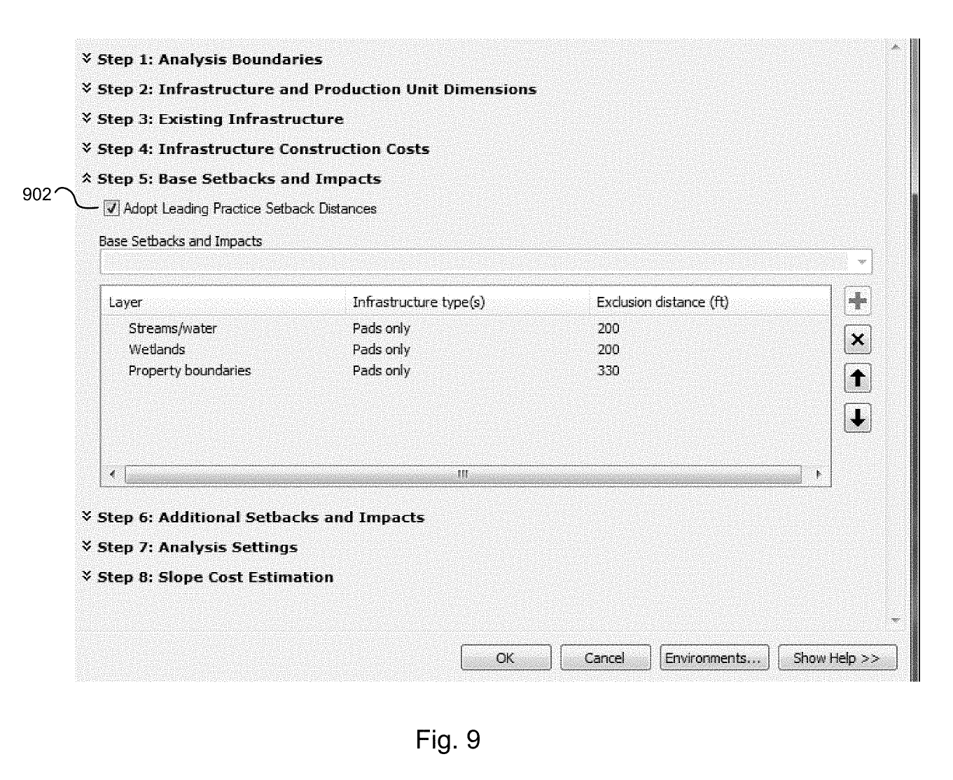

FIG. 9 shows a graphical user interface for displaying oil and gas surface infrastructure placement, impact, and cost information in accordance with an embodiment of the present disclosure. In some implementations, step 5 of user input “Base Setback and Impacts” comprises base setbacks and impacts. In one embodiment, default exclusion distances are provided. For example, the default standard exclusion distance between pads and wetlands is 100 feet in Pennsylvania. In another embodiment, the user may override the default by entering his/her own data. In yet another embodiment, the exclusion distances are doubled if the user clicks on the “Adopt Leading Practice Setback Distances” checkbox 902. For example, if the user clicks on the checkbox 902, the exclusion distance between pads and wetlands will change to 200 feet from 100 feet. In some embodiments, the setback and impact information is displayed in a tabular format. In one embodiment, state regulations are incorporated. As shown in the example provided in FIG. 9, Pennsylvania state regulation requiring 330 feet exclusion distance between pads and property boundaries is incorporated.

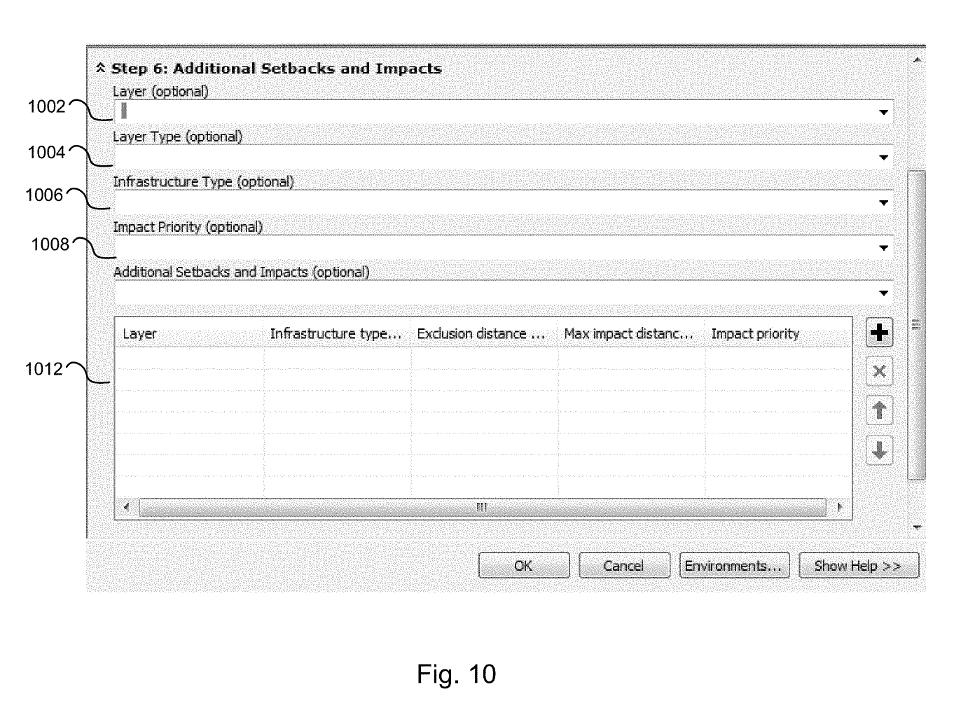

FIG. 10 shows a graphical user interface for displaying oil and gas surface infrastructure placement, impact, and cost information in accordance with an embodiment of the present disclosure. In some implementations, step 6 of user input “Additional Setbacks and Impacts” comprises additional setbacks and impacts that a user may enter. A user may enter layer 1002, layer type 1004, infrastructure type 1006, impact priority 1008. Layer information may be reflected and edited in a tabular format via 1012. For example, a user may enter additional wetland and stream/water information. A user may also enter additional information related to regulations, including drinking water wells, public water supplies, and other existing structures. A user may also specify an exclusion distance and/or an impact distance for ecological features (e.g. eagle nest) and cultural features (e.g., cemeteries, land owner's favorite hunting spot, etc.) entered by the user in this step. In some embodiments, the exclusion distance indicates the minimum buffer distance required in which to exclude placing oil and gas surface infrastructure, and the maximum impact distance indicates the maximum distance from an ecological or cultural feature considered in estimations of environmental impact. For example, a user may enter “eagle nest” for layer 1002, “ecological feature” for layer type 1004, “pads and roads” for infrastructure type 1006, and “medium” for impact priority 1008. A user may also specify exclusion distance and maximum impact distance via tabular data entry 1012.

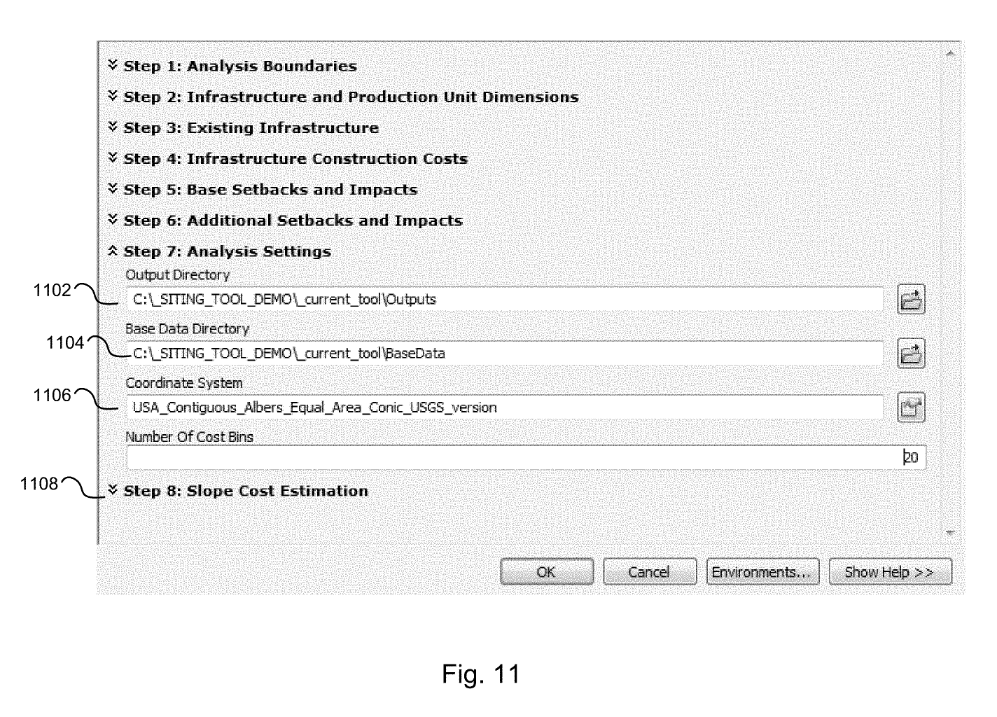

FIG. 11 shows a graphical user interface in accordance with an embodiment of the present disclosure. In some implementations, step 7 of user input “Analysis Settings” comprises analysis settings through which a user may specify output directory 1102, base data directory 1104, and coordinate system 1106. For example, the user may indicate where he/she would like the output to be saved via 1102. The user may also specify where the base data should be read via 1104. In some implementations, 1108 (step 8 of user input “Slope Cost Estimation”) comprises slope cost factor estimation through which a user may enter to estimate the slope cost factor for roads and pipelines if the siting of such infrastructure is located on a slope. In some embodiments, the user may specify the percentage of slope and the corresponding construction cost (in dollars per square foot for roads and in dollars per foot for pipelines), and the corresponding slope cost factors may be calculated.

FIG. 12 shows a graphical user interface for displaying oil and gas surface infrastructure placement, impact, and cost information in accordance with an embodiment of the present disclosure. In some implementations, alternative layouts for well pads, access roads and gathering pipelines are displayed. Each layout is represented in a map representation, with different legends annotating pads, roads, and pipelines. In one embodiment, a user may select one or more specific layers via checkbox 1201 (e.g. road, pipeline, and well pad) and the corresponding layers may be displayed. For example, if the user selects road, then roads 1204 may be displayed in the corresponding map. In some embodiments, as shown in FIG. 12, pads 1202 are shown as squares and annotated at their corresponding locations on a map. Roads 1202 and boundary 1206 are show as lines and annotated at their corresponding locations on a map.

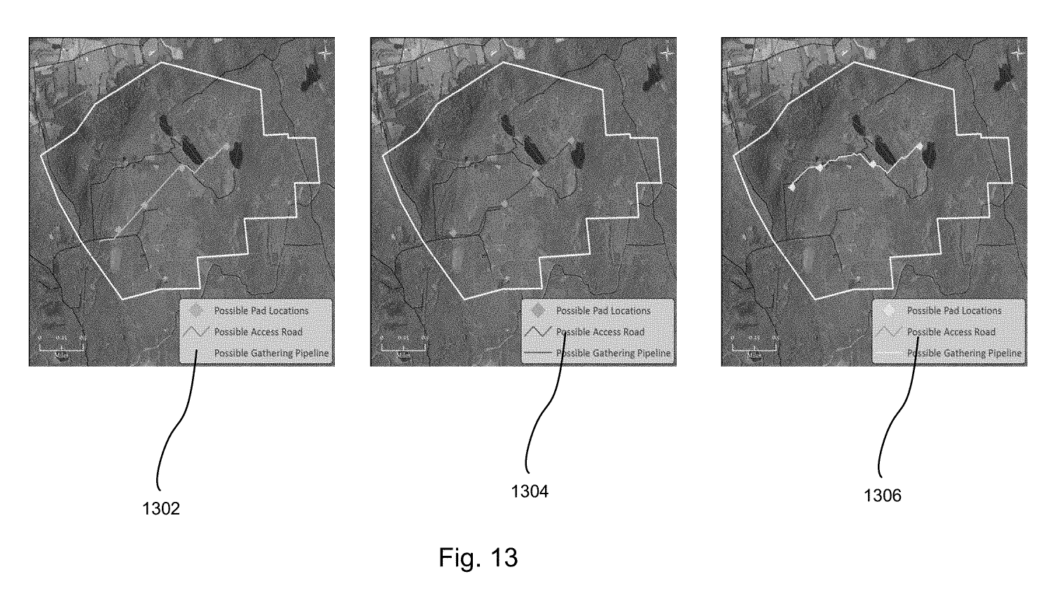

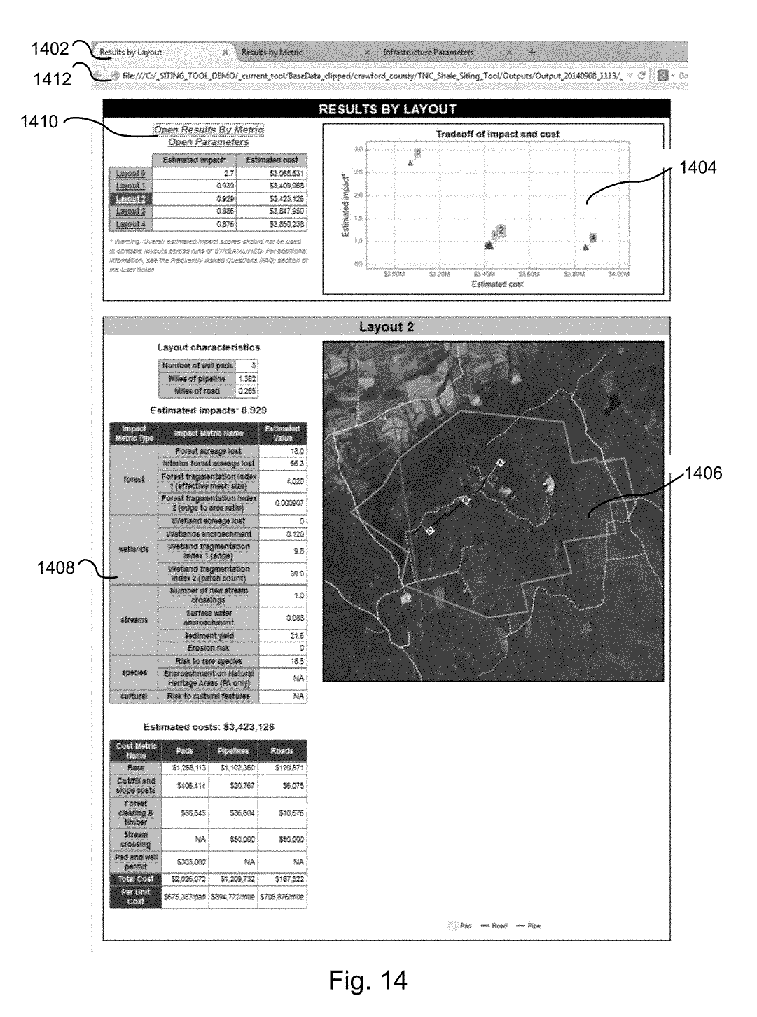

FIG. 13 shows a graphical user interface for displaying oil and gas well drilling information in accordance with an embodiment of the present disclosure. In some implementations, as shown in FIG. 13, different legends annotate different layers, including but not limited to possible pad locations, possible access roads, and possible gathering pipelines. In one embodiment, as shown in FIG. 13, for three different layouts 1302/1304/1306, different color schemes are used for pad locations, possible access roads, and possible gathering pipelines and for different layouts. However, across various layouts, the same legends may be used for pads, roads, and pipelines. Different color schemes of various layouts may facilitate differentiation of the layouts. The same legends may facilitate identification of same type of infrastructure consistently. FIG. 14 shows a graphical user interface for displaying oil and gas surface infrastructure placement, impact, and cost information in accordance with an embodiment of the present disclosure. In some implementations, the output is displayed in three tabs or windows, each tab corresponding to a specific aspect of the output. As shown in FIG. 14, under the “Results by Layout” tab 1402, different layouts and their associated data are shown. In one embodiment, a summary of the alternative layouts is displayed. The summary may include a 2-D graph 1404 that visually displays the impact and cost tradeoff of the alternative layouts, whereby the x-axis represents estimated cost and the y-axis represents the estimated environmental impact. The layout that has the smallest area underneath is the optimized layout, since the product of cost and impact is the smallest. A specific layout is represented in a map 1406 and the associated metrics 1408 are displayed in a tabular format, including but not limited to: (a) Layout Characteristics of “Number of well pads,” “Miles of pipeline,”, and “Miles of road”; (b) Estimated (environmental) Impacts with columns “Impact Metric Type,” “Impact Metric Name,” and “Estimated Value”; and (c) Estimated Costs with columns “Cost/Metric Name,” “Pads,” “Pipelines,” and total cost (per layout) and per unit cost (per pad or per mile). All other layouts and associated metrics may be displayed in the same manner below. Links 1410 that link to other aspects of the output, such as “results by metric” and “parameters” are also provided. As described above, different aspects of the output are saved in different files. In some implementations, at least one aspect of the output is saved in HTML and may be displayed accordingly. Corresponding file directory and file name may be displayed in a web browser file window 1412.

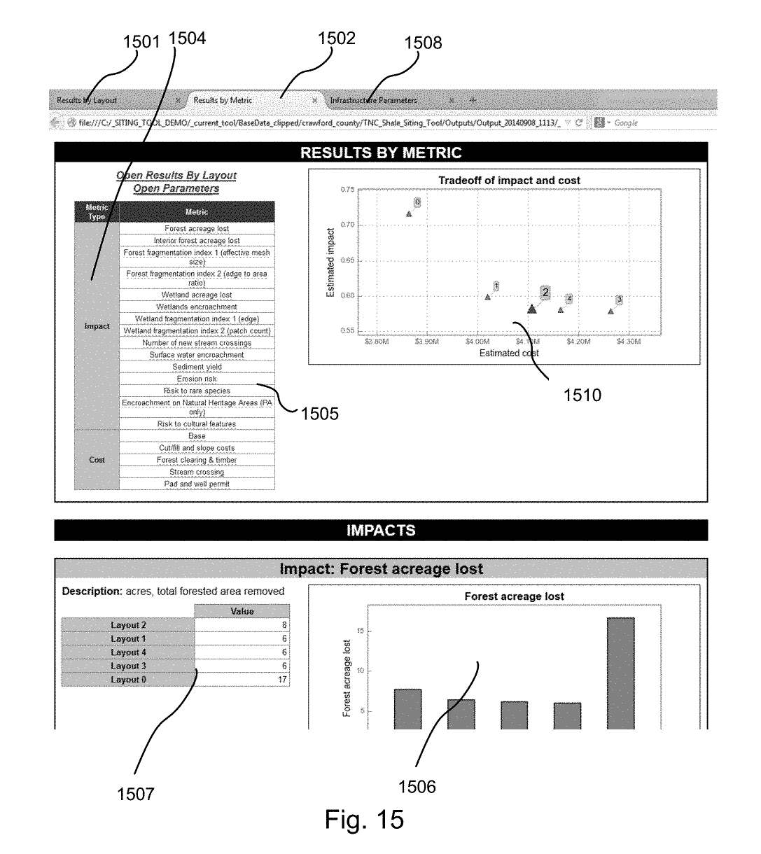

FIG. 15 shows a graphical user interface for displaying oil and gas surface infrastructure placement, impact, and cost information in accordance with an embodiment of the present disclosure. In some implementations, the output is displayed in three tabs or windows: “Results by Layout” 1501, “Results by Metric” 1502, and “Infrastructure Parameters” 1508. As shown in FIG. 15, under the “Results by Metric” tab 1502, results by metric are displayed. In one embodiment, a list 1504 of metrics is displayed comprising links to each metric. Metrics may include forest acreage lost, sediment yield, erosion risk, etc. If a specific metric is clicked on (e.g., link 1505 to metric “forest acreage lost”), the metric may be displayed in detail. In some implementations, the metric is displayed in a bar chart, visually displaying comparisons of a particular metric across alternative layouts. For example, as shown in FIG. 15, a detailed metric 1506 of forest acreage lost is shown in a bar chart. In some embodiments, the metric is shown in a tabular view with metric values of various layouts, for example, table 1507. In one embodiment, if clicked, tab “Infrastructure Parameters” 1508 displays infrastructure parameters in a spreadsheet format. A summary 2-D graph 1510 may also be present to provide visually easy-to-comprehend cost and impact tradeoffs among the alternative layouts.

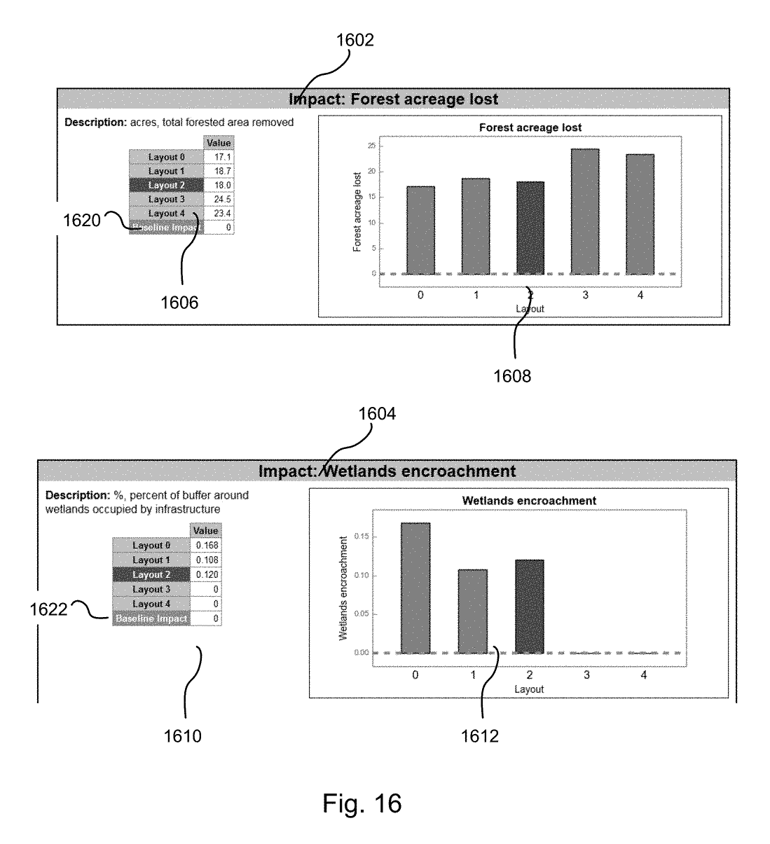

FIG. 16 shows a graphical user interface for displaying oil and gas surface infrastructure placement, impact, and cost information in accordance with an embodiment of the present disclosure. As shown in FIG. 16, a metric 1602 of forest acreage lost and a metric 1604 of wetland encroachment are displayed. In some implementations, optimized layout, in this example layout 2, is highlighted with a color that is different from other alternative layouts. In some embodiments, each detailed metric comprises bar charts (1608/1612) and tabular views (1606/1610). In some embodiments, baseline impact (1620/1622) may also be present. For example, the baseline impact may be “0.”

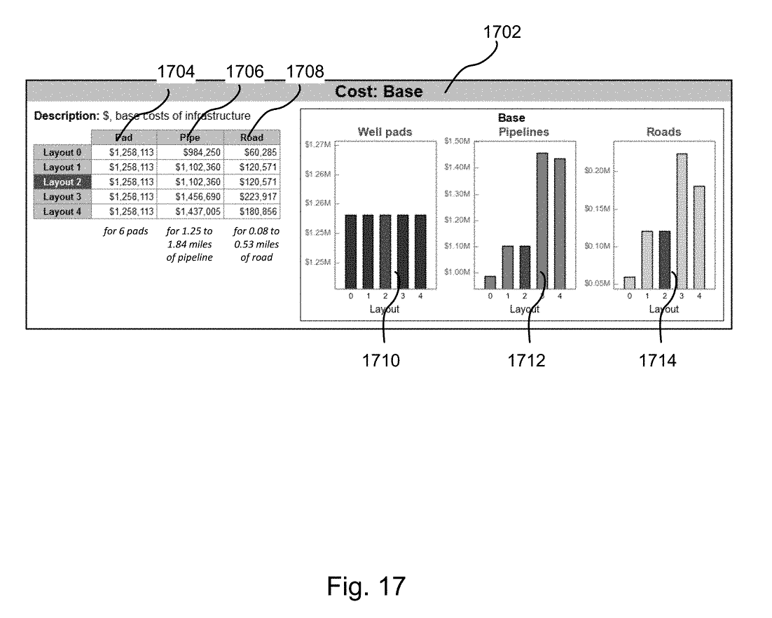

FIG. 17 shows a graphical user interface for displaying oil and gas surface infrastructure placement, impact, and cost information in accordance with an embodiment of the present disclosure. As shown in FIG. 17, a metric 1702 of base cost is shown. In one embodiment, the metric 1702 further comprises sub-metrics. For example, a metric of base cost may further comprise sub-metrics of well pads (1704/1710), pipelines (1706/1712), and roads (1708/1714). In some embodiments, the sub-metrics may be represented with a tubular view (1704/1706/1708). In some embodiments, the sub-metrics may be represented with bar charts (1710/1712/1714).

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

1. A system for positioning energy infrastructure, comprising one or more computer processors configured to:
receive user input, wherein the user input comprises a boundary where energy infrastructure is placed within;
store, in a shareable format, a plurality of layouts for the energy infrastructure and associated metrics and parameters based on the user input and base datasets, wherein the base datasets comprise spatial data; and
output, on a display device, the plurality of layouts for the energy infrastructure and the associated metrics and parameters.

2. The system according to claim 1, wherein the user input comprises at least one of an exclusion distance and a maximum impact distance.

3. The system according to claim 1, wherein at least one of the user input and the base datasets comprises state regulations.

4. The system according to claim 1, wherein the associated metrics comprise tradeoff of cost and environmental impact.

5. The system according to claim 1, wherein the one or more processors are further configured to present one of the plurality of layouts as an optimized layout.

6. The system according to claim 1, wherein the spatial data is based on at least one of existing environmental features and infrastructure, industry standards, or environmental best practices.

7. A method for positioning energy infrastructure, comprising:
receiving user input, wherein the user input comprises a boundary where energy infrastructure is placed within;
storing, in a shareable format, a plurality of layouts for the energy infrastructure and associated metrics and parameters based on the user input and base datasets, wherein the base datasets comprise spatial data; and
outputting, on a display device, the plurality of layouts for the energy infrastructure and the associated metrics and parameters.

8. The method according to claim 7, wherein the user input comprises at least one of an exclusion distance and a maximum impact distance.

9. The method according to claim 7, wherein at least one of the user input and the base datasets comprises state regulations.

10. The method according to claim 7, wherein the associated metrics comprise tradeoff of cost and environmental impact.

11. The method according to claim 7, wherein the one or more processors are further configured to present one of the plurality of layouts as an optimized layout.

12. The method according to claim 7, wherein the spatial data is based on at least one of existing environmental features and infrastructure, industry standards, or environmental best practices.

13. A non-transitory computer readable medium storing a computer-readable program of positioning energy infrastructure, comprising:
computer-readable instructions to receive user input, wherein the user input comprises a boundary where energy infrastructure is placed within;
computer-readable instructions to store, in a shareable format, a plurality of layouts for the energy infrastructure and associated metrics and parameters based on the user input and base datasets, wherein the base datasets comprise spatial data; and
computer-readable instructions to output, on a display device, the plurality of layouts for the energy infrastructure and the associated metrics and parameters.

14. The non-transitory computer readable medium according to claim 13, wherein the user input comprises at least one of an exclusion distance and a maximum impact distance.

15. The non-transitory computer readable medium according to claim 13, wherein at least one of the user input and the base datasets comprises state regulations.

16. The non-transitory computer readable medium according to claim 13, wherein the associated metrics comprise tradeoff of cost and environmental impact.

17. The non-transitory computer readable medium according to claim 13, wherein the one or more processors are further configured to present one of the plurality of layouts as an optimized layout.

18. The non-transitory computer readable medium according to claim 13, wherein the spatial data is based on at least one of existing environmental features and infrastructure, industry standards, or environmental best practices.
